(19) United States
(12) Patent Application Publication
(10) Pub. No.: US 2011/0063651 A1
(43) Pub. Date: Mar. 17, 2011

(54) Job management system, information processing apparatus, and information processing method

(75) Inventor: Mikinori Ehara, Kanagawa (JP)

(73) Assignee: Ricoh Company, Ltd., Tokyo (JP)

(21) Appl. No.: 12/923,215

(22) Filed: Sep. 9, 2010

(30) Foreign Application Priority Data
Sep. 15, 2009 (JP) 2009-213752

(51) Int. Cl. G06F 3/12

(52) U.S. Cl. 358/1.14; 358/1.15

(57) ABSTRACT

Disclosed is a job management system having plural information processing apparatuses connected to each other via a network capable of transmitting and receiving information. The information processing apparatus include a job control unit that selects one of the plural information processing apparatuses to execute a requested job based on user's registration information and equipment information recorded in the plural information processing apparatuses and causes the selected one of the plural information processing apparatuses to execute the requested job.

### BACKGROUND OF THE INVENTION

1. Field of the Invention

The present invention relates to a job management system, an information processing apparatus, and an information processing method.

2. Description of the Related Art

In recent years and continuing to the present, information processing systems, which are capable of communicating documents in various data formats between plural information processing apparatuses connected to a network with plural communication protocols, have been developed.

In such information processing systems, various application services based on the information processing apparatuses are provided. The information processing apparatuses manage the application services as jobs and execute them with predetermined timing. Examples of the application services include transmission of document images scanned by, e.g., a scanner and data items generated by the information processing apparatuses to designated addresses via e-mail and facsimile; transferring of such document images and data items between the information processing apparatuses in the form of files; printing and outputting of received facsimile images, attached file images of e-mail, etc.; transmission of such received facsimile images and attached file images to designated FAX machines; transferring of such facsimile images and attached file images between the information processing apparatuses in the form of files; and accumulating and managing of data for the information processing apparatuses.

Note that even if processing capable of being executed by the respective information processing apparatuses on the information processing system are different from each other, the application services can be executed based on a mutually dependent relationship between the information processing apparatuses.

For example, Patent Document 1 proposes a method in which an apparatus having no facsimile transmission function executes facsimile transmission by using another apparatus on a network having the facsimile transmission function.

However, the invention disclosed in Patent Document 1 cannot limit the apparatus which executes the processing for each user. Furthermore, in companies, it is likely that fees for processing and maintaining information processing apparatuses are settled for each department so as to enhance cost-consciousness. For example, with respect to facsimile transmission and reception, apparatuses and lines are specified for each department, and communication fees for the lines are charged to the corresponding department. Also, apparatuses used for printing and storing data are specified for each department, and fees for maintaining the used information processing apparatuses are settled for the corresponding department.

Moreover, in the case of e-mail transmission and file transmission, apparatuses capable of being connected to the Internet are limited. Therefore, e-mails and files may not be transmitted unless such apparatuses are used.

Thus, for example, if the plural information processing apparatuses are limited depending on users in the information processing system in which the information processing apparatuses are connected to one another on the network, the users are forced to consciously select one of the information processing apparatuses, which results in an increase in labor of the users. In addition, the users may wrongly select the information processing apparatus.

Patent Document 1: JP-A-2003-179718

### SUMMARY OF THE INVENTION

The present invention has been made in view of the above points and may provide a job management system, an information processing apparatus, and an information processing method in which the user selects an information processing apparatus connected to a network based on predetermined conditions so as to execute a job without selecting the corresponding one of plural information processing apparatuses for executing the job.

According to an aspect of the present invention, there is provided a job management system having plural information processing apparatuses connected to each other via a network capable of transmitting and receiving information. The information processing apparatus includes a job control unit that selects one of the plural information processing apparatuses to execute a requested job based on user's registration information and equipment information recorded in the plural information processing apparatuses and causes the selected one of the plural information processing apparatuses to execute the requested job.

According to another aspect of the present invention, there is provided an information processing apparatus connected to plural of the information processing apparatuses via a network capable of transmitting and receiving information. The information processing apparatus includes a job control unit that selects one of the plural information processing apparatuses to execute a requested job and causes the selected one of the plural information processing apparatuses to execute the job.

According to still another aspect of the present invention, there is provided an information processing method executed by a job management system having plural information processing apparatuses connected to each other via a network capable of transmitting and receiving information. The information processing method includes a selection step of selecting one of the plural information processing apparatuses to execute a requested job based on user's registration information and equipment information recorded in the plural information processing apparatuses; and a job control step of causing the one of the plural information processing apparatuses selected by the selection step to execute the requested job.

Other objects, features and advantages of the present invention will become more apparent from the following detailed description when read in conjunction with the accompanying drawings.

### BRIEF DESCRIPTION OF THE DRAWINGS

FIG. 1 is a diagram showing the schematic configuration of a job management system according to an embodiment;

FIG. 2 is an external perspective view schematically showing a digital color multifunction peripheral according to the embodiment;

FIG. 3 is a block diagram showing electrical connections between the respective units of the digital color multifunction peripheral according to the embodiment;

FIG. 4 is a block diagram showing the functions of the digital color multifunction peripheral according to the embodiment;

FIG. 5 is a diagram showing an example of user information recorded in a registration information DB according to the embodiment;

FIGS. 6A and 6B are diagrams showing an example of group information recorded in the registration information DB according to the embodiment;

FIG. 7 is a diagram showing an example of equipment information recorded in the equipment information DB according to the embodiment;

FIG. 8 is a diagram showing an example of image information recorded in the image information DB according to the embodiment;

FIG. 9 is a diagram showing an example of history information recorded in a history information DB according to the embodiment;

FIG. 10 is a flowchart showing the flow of job execution processing according to the embodiment; and

FIG. 11 is a flowchart showing the flow of the execution processing of a job control unit according to the embodiment.

### DETAILED DESCRIPTION OF THE PREFERRED EMBODIMENTS

Hereinafter, an embodiment of the present invention is described in detail.

(Schematic Configuration of Job Management System)

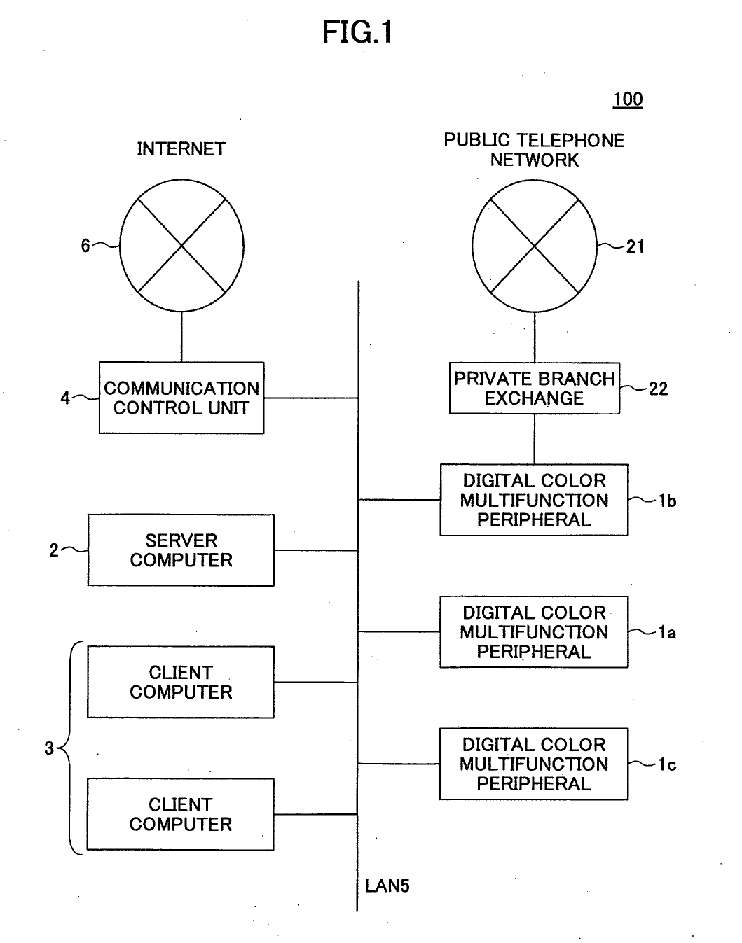

Referring first to FIG. 1, a description is made of the schematic configuration of a job management system according to the embodiment. FIG. 1 shows the schematic configuration of the job management system according to the embodiment. Note that the job management system 100 shown in FIG. 1 shows a system configuration including equipment (information processing apparatus) such as a digital color multifunction peripheral as an example.

Note that the digital color multifunction peripheral refers to equipment that has, e.g., a copy function, a facsimile (FAX) function, a print function, a scanner function, and the function of distributing input images (document images scanned by the scanner function and images input by the printer function or the FAX function).

The job management system 100 shown in FIG. 1 is configured to include digital color multifunction peripherals 1a through 1c, a server computer 2, client computers 3, and a communications control unit 4.

Further, the job management system 100 connects the plural digital color multifunction peripherals 1a through 1c (hereinafter collectively referred to as “digital color multifunction peripherals 1”) to the server computer 2 that executes various information processing programs and to the plural client computers 3 via a LAN (Local Area Network) 5 as a communications network.

Here, the job management system 100 develops an environment in which an image input function such as a scanner function, an image output function such as a print function, and an image processing function such as the function of accumulating images, provided in the respective digital color multifunction peripherals 1, can be shared on the LAN 5.

The server computer 2 supports, e.g., FTP and HTTP protocols and implements the functions of a Web server and a DNS (domain name server).

Further, the job management system 100 has a communications control unit 4, is connected to an Internet network 6 via the communications control unit 4, and configured to be capable of communicating data with an external environment via the Internet network 6.

The communications control unit 4 refers to, e.g., a router, switching equipment, and a modem, and is capable of performing, e.g., TCP/IP communications. Note that the LAN 5 is not limited to one using wired communications but may be in other forms using wireless communications (such as infrared rays and electric waves) and optical fibers.

Further, the digital color multifunction peripherals 1 connected to the job management system 100 are connected to a public telephone network 21 via a PBX (Private Branch Exchange) 22 and can communicate with remote FAX machines via the public telephone network 21. Examples of a facsimile line include G3-1, G3-2, and G4.

In the job management system 100 according to the embodiment, processing as instructed by the user is automatically executed by a previously-set apparatus regardless of which one of the digital color multifunction peripherals 1a through 1c he or she uses.

For example, in the job management system 100, it is assumed that members belonging to a “group 1” are required to perform Fax transmission with the line G3-1 of the digital color multifunction peripheral 1b. In this case, even if a “user 1” belonging to the “group 1” performs FAX transmission with one of the digital color multifunction peripherals 1a through 1c, the line G3-1 of the digital color multifunction peripheral 1b is automatically used to perform FAX transmission.

As described above, the conditions, etc., of the equipment to be used are set in advance for each user in the job management system 100 according to the embodiment, whereby various processing jobs such as e-mail transmission, file transfer, print output, and data accumulation other than FAX transmission are executed by the specified equipment.

(Digital Color Multifunction Peripheral)

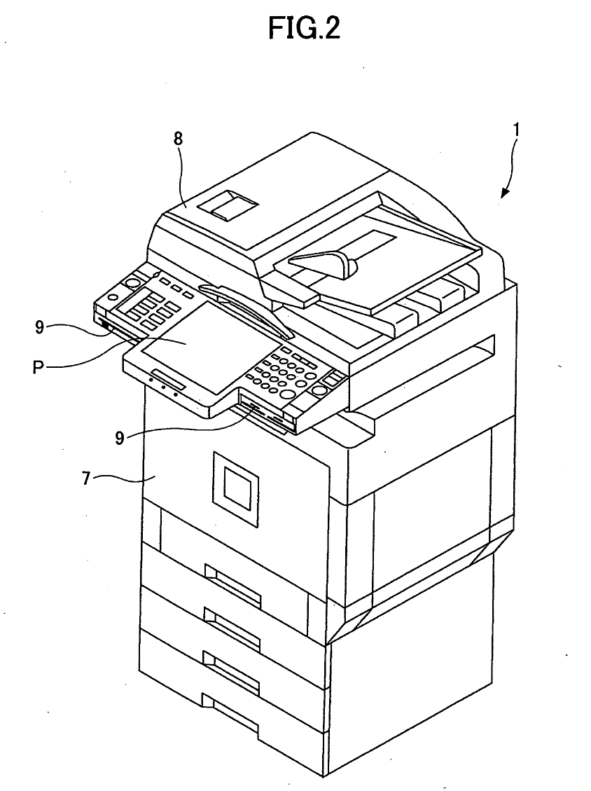

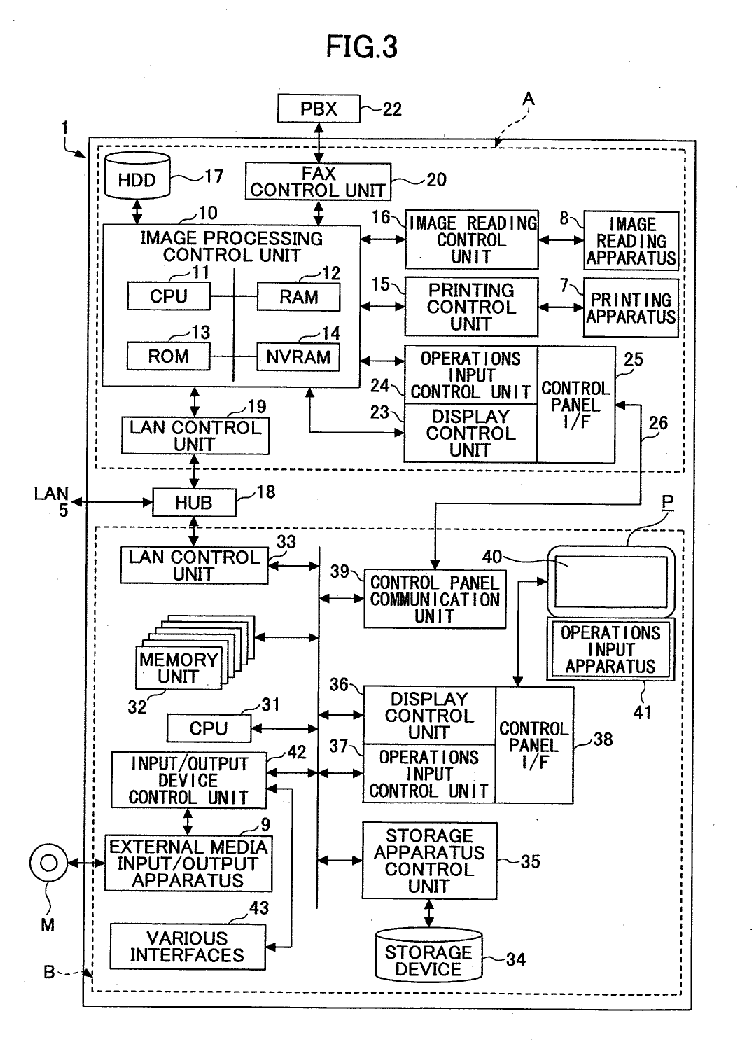

Referring next to FIGS. 2 and 3, a description is made of the digital color multifunction peripheral 1. FIG. 2 is an external perspective view schematically showing the digital color multifunction peripheral. FIG. 3 is a block diagram showing electrical connections between the respective units of the digital color multifunction peripheral.

The digital color multifunction peripheral 1 shown in FIG. 2 is configured to mainly include a printing apparatus 7, an image reading apparatus 8, and an external media input/output apparatus 9. Further, the digital color multifunction peripheral 1 shown in FIG. 3 is configured to include an image processing unit section A and an information processing unit section B.

As shown in FIG. 2, in the digital color multifunction peripheral 1, the image reading apparatus 8 that reads an image from a document is provided above the printing apparatus 7 as an image forming apparatus that forms an image on a medium such as a transfer sheet. Further, at the external surface of the image reading apparatus 8, an operations panel P is provided to display information to the user and receive various inputs such as function settings from the user.

Moreover, under the operations panel P, the external media input/output apparatus 9 is provided. The external media input/output apparatus 9 reads program code, image data, etc., stored in a storage medium M such as an optical disk and a flexible disk described below, and writes the program code, image data, etc., in the storage medium M. Note that the external media input/output apparatus 9 has an insertion slot exposed externally to receive the storage medium M.

Further, as shown in FIG. 3, the electrical connections of the digital color multifunction peripheral 1 are roughly divided into the image processing unit section A and the information processing unit section B. The image processing unit section A includes the printing apparatus 7 and the image reading apparatus 8, and the information processing unit section B includes the operations panel P and the external media input/output apparatus 9.

Here, the image processing unit section A is described. The image processing unit section A includes an image processing control unit 10, and the image processing control unit 10 controls all of the image processing in the image processing unit section A.

The image processing control unit 10 is composed of, e.g., a microcomputer, and has a CPU (Central Processing unit) 11, a RAM (Random Access Memory) 12, and a NVRAM (Nonvolatile Random Access Memory) 14, all of which are connected to one another through a bus. Note that the CPU 11 serves as a main processor; the RAM 12 temporarily stores image data read from the image reading apparatus 8 so as to be subjected to image formation processing, etc., by the printing apparatus 7; the ROM 13 stores a control program, etc.; and the NVRAM 14 records system logs, system settings, log information, etc., and is capable of maintaining data even when power is turned off.

The image processing control unit 10 is connected to a printing control unit 15 that controls the printing apparatus 7 and to an image reading control unit 16 that controls the image reading apparatus 8.

The printing control unit 15 outputs a printing instruction accompanying image data to the printing apparatus 7 in accordance with a request from the image processing control unit 10, and the printing apparatus 7 forms an image on a medium such as a transfer sheet and outputs the same. Note that the printing apparatus 7 is capable of performing full-color printing.

The image reading control unit 16 drives the image reading apparatus 8 in accordance with a request from the image processing control unit 10, and the image reading apparatus 8 condenses reflection light by lamp irradiation at the front surface of a document into a light receiving element through a mirror and a lens so as to be read. Thus, digital image data are generated.

Further, the image processing control unit 10 is connected to a HDD (Hard Disk Drive) 17 that serves to accumulate large amounts of image data and store job history, etc.; a LAN control unit 19 that connects the image processing unit section A to a LAN 5 through a HUB 18 as a line concentrator provided inside the digital color multifunction peripheral; and a FAX control unit 20 that performs FAX control.

The FAX control unit 20 is connected to the PBX 22 communicating with the public telephone network 21.

Further, the image processing control unit 10 is connected to a display control unit 23 and an operations input control unit 24. Under the control of the image processing control unit 10, the display control unit 23 outputs an image display control signal to the information processing unit section B through a communication cable 26 connected to a control panel I/F 25, thereby controlling the display of an image with respect to the operations panel P of the information processing unit section B.

Under the control of the image processing control unit 10, the operations input control unit 24 receives an input control signal in accordance with function settings and input operations by the user from the operations panel P of the information processing unit section B through the communication cable 26 connected to the control panel I/F 25. In other words, the image processing unit section A is configured to be capable of directly monitoring the operations panel P of the information processing unit section B through the communication cable 26.

With this configuration, the image processing unit section A analyzes printing data as image information from an outside (the server computer 2, the client computers 3, a FAX machine, etc.) and a command to perform printing, and determines operations.

Further, the image processing unit section A can transfer printing data, document reading data, output image data obtained by processing the printing data and the document reading data for outputting, compression data obtained by compressing the printing data, the document reading data, and the output image data, all of which are stored in the RAM 12 and the HDD 17, to the outside (the server computer 2, the client computers 3, the FAX machine, etc.).

Next, the information processing unit section B having the operations panel P is described. The information processing unit section B is composed of, e.g., a microcomputer controlled by a general-purpose OS (Operating System) used for an information processing apparatus such as a personal computer.

The information processing unit section B has a CPU 31 as a main processor.

The CPU 31 is connected to a memory unit 32 and a storage apparatus control unit 35 through a bus. Note that the memory unit 32 is configured to include a RAM as the work area of the CPU 31 and a ROM as a read only memory storing an activation program, etc. Further, the storage apparatus control unit 35 controls the input/output of data to/from a storage device 34 such as a HDD storing application programs.

Further, the CPU 31 is connected to a LAN control unit 33 as a communication interface used for connecting the information processing unit section B to the LAN 5 through the HUB 18. Note that an IP address as a network address allocated to the LAN control unit 33 is different from that allocated to the LAN control unit 19 of the image processing unit section A.

In other words, the two IP addresses are allocated to the digital color multifunction peripheral 1 according to the embodiment, and the image processing unit section A and the information processing unit section B are connected to the LAN 5. Thus, data exchange between the image processing unit section A and the information processing unit section B is made possible.

Further, the CPU 31 is connected to a display control unit 36 and an operations input control unit 37 to control the operations panel P. Further, the CPU 31 is connected to a control panel communication unit 39 connected to the control panel I/F 25 of the image processing unit section A through the communication cable 26.

The control panel communication unit 39 receives an image display control signal output from the image processing unit section A, and transfers to the image processing unit section A the input control signal in accordance with function settings and input operations by the user from the operations panel P.

As described above, the storage device 34 stores the OS and the application programs executed by the CPU 31.

In the job management system 100 according to the embodiment, by the system configuration including the digital color multifunction peripheral 1 described above, one of the plural digital color multifunction peripherals 1 is automatically selected depending on the user who uses a system to execute a job as instructed by the user.

Next, the details of the processing executed by the digital color multifunction peripheral 1 are described.

(Function Block of Digital Color Multifunction Peripheral)

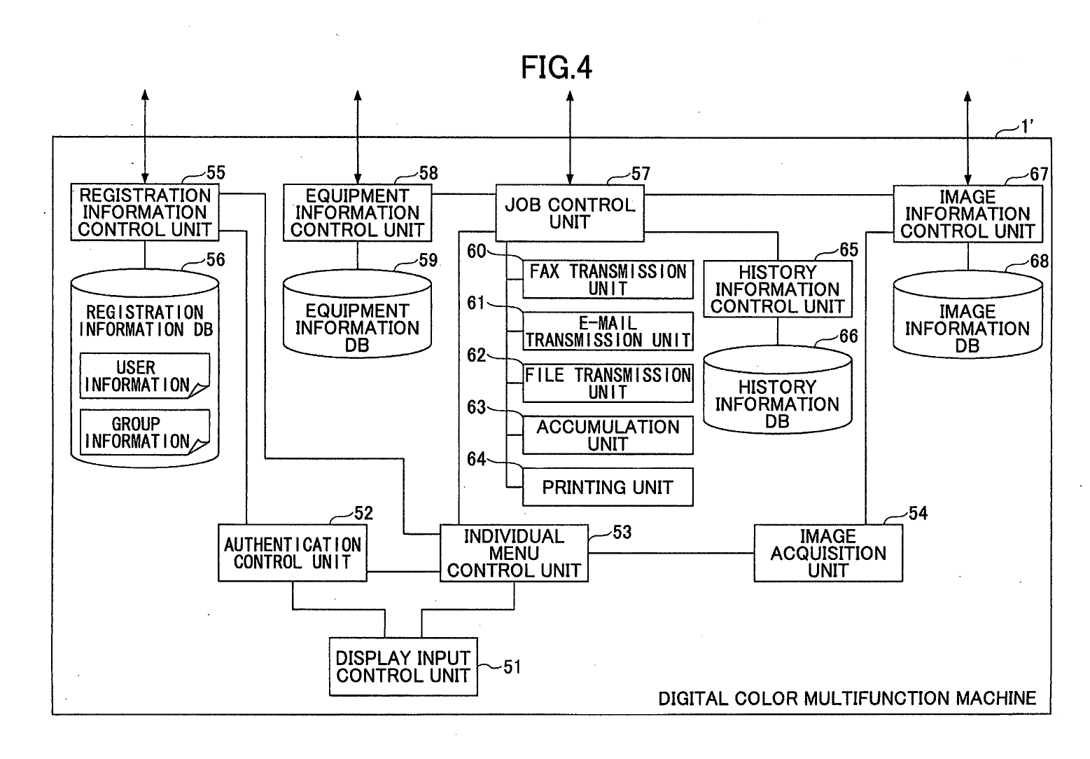

Referring first to FIG. 4, a description is made of a function block diagram showing relationships between functions for implementing the processing of the digital color multifunction peripheral 1. FIG. 4 is the function block diagram of the digital color multifunction peripheral 1 according to the embodiment.

As shown in FIG. 4, the digital color multifunction peripheral 1 is configured to include a display input control unit 51, an authentication control unit 52, an individual menu control unit 53, an image acquisition unit 54, a registration information control unit 55, a registration information DB 56, a job control unit 57, an equipment information control unit 58, an equipment information DB 59, an image information control unit 67, an image information DB 68, a history information control unit 65, and a history information DB 66.

The display input control unit 51 controls various displays and inputs. For example, the display input control unit 51 displays a screen on the operations panel P, and receives operations by the user for setting conditions, such as inputting of authentication information using a user name, a password, etc., reading of a document image, and transmission, accumulation, and printing of a read image, etc.

The authentication control unit 52 compares authentication information acquired from the display input control unit 51 with user information acquired from the registration information control unit 55 to perform user authentication. When the user authentication by the authentication control unit 52 is successful, the individual menu control unit 53 then performs control. Note that when the user authentication fails, the authentication control unit 52 instructs the display input control unit 51 to display an authentication error message.

The individual menu control unit 53 maintains information for each login user and requests for displaying a screen and executing processing for the user. The individual menu control unit 53 acquires user information, group information, etc., as registration information of the login user from the registration information control unit 55, and instructs the display input control unit 51 to display the screen dedicated to the user based on the acquired information.

Further, the individual menu control unit 53 acquires from the display input control unit 51 values for setting the conditions of the transmission, accumulation, printing, etc., of a document image input by the user, etc., requests the image acquisition unit 54 to acquire an image based on the set information, and requests the job control unit 57 to execute a job.

The image acquisition unit 54 reads an image from a scanner and acquires an image file from a medium. The image acquisition unit 54 causes the image information control unit 67 to store an acquired image in the HDD 17 of the digital color multifunction peripheral. The image acquisition unit 54 acquires image information such as a destination to store a file from the image information control unit 67 and outputs the acquired image information to the individual menu control unit 53.

The registration information control unit 55 records user information, group information, etc., as user's registration information described below in the registration information DB 56, and is instructed by the authentication information control unit 52 and the individual menu control unit 53 to acquire the user's registration information from the registration information DB 56 and output the same to each of the control units. Further, the registration information control unit 55 synchronizes the user's registration information recorded in the registration information DB 56 with those recorded in other multifunction peripherals existing on the network. Note that the control of synchronizing the user's registration information is described below.

The registration information DB 56 records the user's registration information. Further, upon receiving a notification from the registration information control unit 55, the registration information DB 56 executes the acquisition, addition, change, deletion, etc., of the user information, group information, etc., as the user's registration information.

The job control unit 57 includes a FAX transmission unit 60, an e-mail transmission unit 61, a file transmission unit 62, an accumulation unit 63, and a printing unit 64. Upon receiving an instruction from the individual menu control unit 53, the job control unit 57 causes a requested job to be executed.

For example, when being connected through the network capable of transmitting and receiving information to and from plural information processing apparatuses, the job control unit 57 receives an instruction for executing a job requested by the user with the operations panel P of the own digital multifunction peripheral, the client computer 3, etc., and selects one of the plural information processing apparatuses to execute the job based on the user's registration information and the equipment information of the plural information processing apparatuses.

On this occasion, the job control unit 57 acquires the user's registration information from the individual menu control unit 53 and determines whether any information processing apparatus for executing the job is specified based on the acquired user's registration information. When it is determined that the information processing apparatus for executing the job is specified, the job control unit 57 determines whether the specified information processing apparatus is available based on the equipment information acquired from the equipment information control unit 58. When it is determined that the specified information processing apparatus is available, the job control unit 57 selects it as the information processing apparatus for executing the job.

Further, when it is determined that plural information processing apparatuses are specified and at least two of the specified plural information processing apparatuses are available, the job control unit 57 causes the user to select one of the information processing apparatuses for executing the job. Note here that when information for specifying equipment to be preferentially used is set for each user, the job control unit 57 may select the information processing apparatus for executing the job based on the set information for specifying the equipment.

Further, when executing the job with other multifunction peripherals existing on the network, the job control unit 57 instructs the job control units 57 of these other multifunction peripherals to execute the job.

As described above, since the information processing apparatus for executing the job is automatically selected, the user is not required to select one of the plural information processing apparatuses by himself or herself. Therefore, it is possible for the user to execute the job without wrongly selecting the apparatus to be used.

Note here that the equipment information refers to the various information items of the equipment including the information processing apparatus such as the multifunction peripheral, and is used for determining whether the job is capable of being executed based on the conditions of the equipment such as the availability of a FAX machine and the available lines for the corresponding equipment.

Further, the job control unit 57 acquires user's registration information from the individual menu control unit 53 and causes the information processing apparatus capable of being used by the user to execute the job based on the acquired user's registration information. Thus, it becomes possible to correctly select the equipment corresponding to the user and prevent unregistered persons from using the equipment.

The job control unit 57 acquires an image file required for executing the job from the image information control unit 67 based on image information supplied by the individual menu control unit 53. Here, the image information refers to information such as a destination at which to store the image file.

The job control unit 57 instructs one of the e-mail transmission unit 60, the FAX transmission unit 61, the file transmission unit 62, the accumulation unit 63, and the printing unit 64 to execute the job in accordance with the details of the job to be processed.

Further, after executing the job, the job control unit 57 notifies the history information control unit 65 of an execution result.

The equipment information control unit 58 records the equipment information in the equipment information DB 59. On the other hand, upon receiving a notification from the job control unit 57, the equipment information control unit 58 acquires the equipment information from the equipment information DB 59 and outputs the same to the job control unit 57. The equipment information control unit 58 synchronizes the equipment information items recorded in the equipment information DB 59 with those recorded in other multifunction peripherals existing on the network. Note that the control of synchronizing the equipment information is described below.

The equipment information DB 59 includes the equipment information. Upon receiving a notification from the equipment information control unit 58, the equipment information DB 59 executes the acquisition, addition, change, deletion, etc., of the recorded equipment information.

The FAX transmission unit 60 transmits the image file by facsimile in accordance with an instruction from the job control unit 57 and notifies the job control unit 57 of a transmission result.

The e-mail transmission unit 61 transmits the image file by e-mail in accordance with an instruction from the job control unit 57 and notifies the job control unit 57 of a transmission result.

The file transmission unit 62 transfers the image file to an information processing apparatus in accordance with an instruction from the job control unit 57 and notifies the job control unit 57 of a transfer result.

The accumulation unit 63 accumulates the image file in the HDD 17 in accordance with an instruction from the job control unit 57 and notifies the job control unit 57 of an accumulation result.

The printing unit 64 prints the image file in accordance with an instruction from the job control unit 57 and notifies the job control unit 57 of a print result.

Upon receiving the notification of a job execution result from the job control unit 57, the history information control unit 65 stores the job execution result in the history information DB 66.

The history information DB 66 includes the execution history of the job. Upon receiving a notification from the history information control unit 65, the history information DB 66 executes the acquisition, addition, change, deletion, etc., of history information.

Upon receiving the notification of acquiring the image file from the image acquisition unit 54, the image information control unit 67 performs processing such as storage of the image file in the HDD 17 and storage of information on a destination to store in the image information DB 68. Further, upon receiving a notification from the job control unit 57, the image information control unit 67 acquires the image file used for executing the job and notifies the job control unit 57 of the same.

Further, the image information control unit 67 performs control for synchronizing image information with those of other multifunction peripherals existing on the network. Note that the control of synchronizing the image information is described below.

The image information DB 68 includes information on the image file. Upon receiving a notification from the image information control unit 68, the image information DB 68 executes the acquisition, addition, change, deletion, etc., of the image information.

(Synchronization of Information Between Plural Multifunction Peripherals on Network)

Next, a description is made of a method for synchronizing the user's registration information, equipment information, image information, etc., described above between the plural multifunction peripherals on the network.

The synchronization of the respective information items is implemented by communications between the registration information control units 55, the equipment information control units 58, and the image information control units 67 of the respective multifunction peripherals. Here, as an example, a description is made of a case in which the registration information control units 55 synchronize the user's registration information among the respective multifunction peripherals on the network. For example, the registration information control units of the digital color multifunction peripherals 1a through 1c are referred to as registration information control units 55a through 55c, respectively.

For example, when the user's registration information described above is changed in the digital color multifunction peripheral 1a, the registration information control unit 55a notifies the network of the change in the user's registration information. When receiving the notification from the registration information control unit 55a, the registration information control unit 55b of the multifunction peripheral 1b and the registration information control unit 55c of the multifunction peripheral 1c on the network request the registration information control unit 55a to transmit information on the change.

The registration information control unit 55a transmits the information on the change to the registration information control unit 55b and the registration information control unit 55c.

When the registration information control unit 55b and the registration information control unit 55c reflect the information on the change in their user's registration information, the synchronization of the registration information held in the digital color multifunction peripherals 1a through 1c is made possible.

Note that the above method is an example of synchronizing the information between the plural multifunction peripherals. Alternatively, it may also be possible to provide a shared folder in the server computer 2 or the client computer 3 and store the newest information in the shared folder. In this case, the registration information control units 55a through 55c regularly access the shared folder for synchronization on the network. When the shared folder contains information newer than that contained in the registration information control units 55a through 55c, the registration information control units 55a through 55c acquire the newer information and reflect the same in their information. Further, when the shared folder contains information older than that of the registration information control units 55a through 55c, the registration information control units 55a through 55c update the information of the shared folder with their newer information.

Thus, sharing the newest information among the plural multifunction peripherals on the network is made possible. As a result, it is possible for the user to use the same service regardless of which one of the digital color multifunction peripherals on the network he or she uses.

Next, the information handled by the respective control units is described.

(Various Information Items)

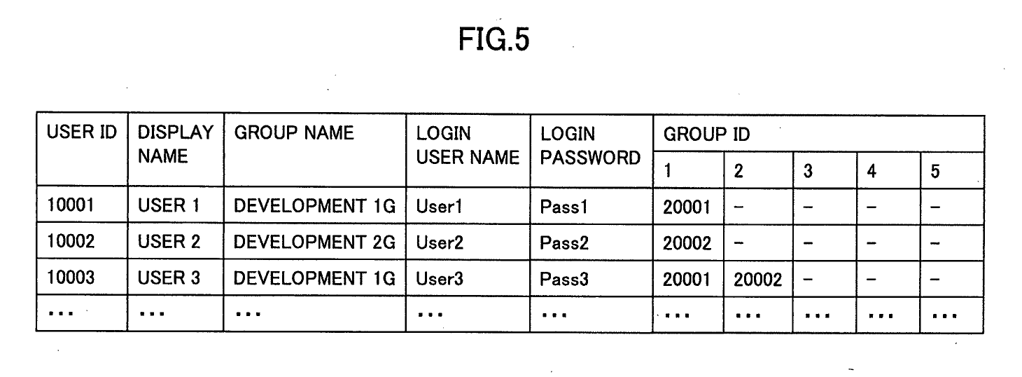

Referring next to FIG. 5, a description is made of the user information recorded in the registration information DB 56 according to the embodiment. FIG. 5 is a diagram showing an example of the user information recorded in the registration information DB according to the embodiment.

As shown in FIG. 5, “user IDs,” “display names,” “group names” “login user names,” “login passwords,” “group IDs,” etc., are recorded as the user information of the registration information DB 56.

Here, the “display names” and the “group names” are, e.g., information displayed on the screen, and the “login user names” and the “login passwords” are information used for authentication. Further, the “group IDs” contain the IDs of groups to which users belong.

As shown in FIG. 5, when the “user ID” is, e.g., “10001,” “user 1” is displayed as the “display name” and “development 1G” is displayed as the “group name.” Further, “Userl” as the “login user name” and “Passl” as the “login password” are used for authentication. Moreover, the “group ID” of the group to which the “user 1” belongs is “20001.”

Further, when the “user ID” is, e.g., “10003,” “user 3” is displayed as the “display name” and “development 1G” is displayed as the “group name.” Further, “User3” as the “login user name” and “Pass3” as the “login password” are used for authentication. Moreover, the “group ID” of the group to which the “user 3” belongs includes “20001” and “20002.”

As described above, recording of the plural group IDs in the “group ID” makes it possible to select and record the plural groups in the user information. Note that according to the embodiment, the setting information of the groups to which the respective users belong is acquired by the use of the “group ID” described above.

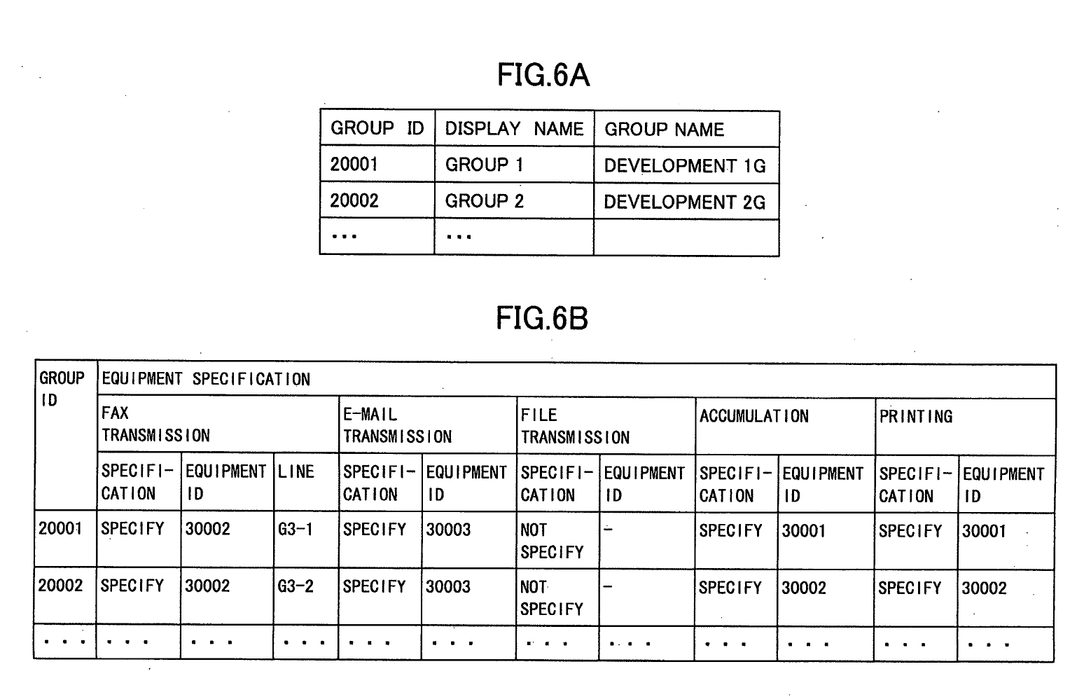

Referring next to FIGS. 6A and 6B, a description is made of the group information recorded in the registration information DB 56 according to the embodiment. FIGS. 6A and 6B are diagrams showing an example of the group information recorded in the registration information DB 56 according to the embodiment.

As an example of the group information of the registration information DB 56, FIG. 6A shows the display information of the groups, and FIG. 6B shows the equipment specification information of the groups.

As shown in FIG. 6A, the display information of the groups is the information to be displayed on the screen for a login user. When the “group ID” is, e.g., “20001,” “group 1” is displayed as the “display name” and “development 1G” is displayed as the “group name.”

Further, as shown in FIG. 6B, the equipment specification information indicates information as to whether equipment to be used is specified for each processing, information as to which equipment is used if the equipment to be used is specified, etc. In the area of “equipment specification,” information as to whether equipment is specified, information on the specified equipment, etc., are recorded for each of the processing of “FAX transmission,” “e-mail transmission,” “accumulation,” “printing,” etc.

Specifically, as shown in FIG. 6B, when the “group ID” is “20001,” it is recorded in the equipment specification that “equipment is specified” for the processing of “FAX transmission,” “e-mail transmission,” “accumulation,” and “printing,” while “equipment is not specified” for the processing of “file transmission.” Further, for the processing of “FAX transmission,” it is specified that equipment having an “equipment ID” of “30002” and a “line” of “G3-1” is used. As described above, it is possible to specify the line as well as the equipment in, e. Fax transmission.

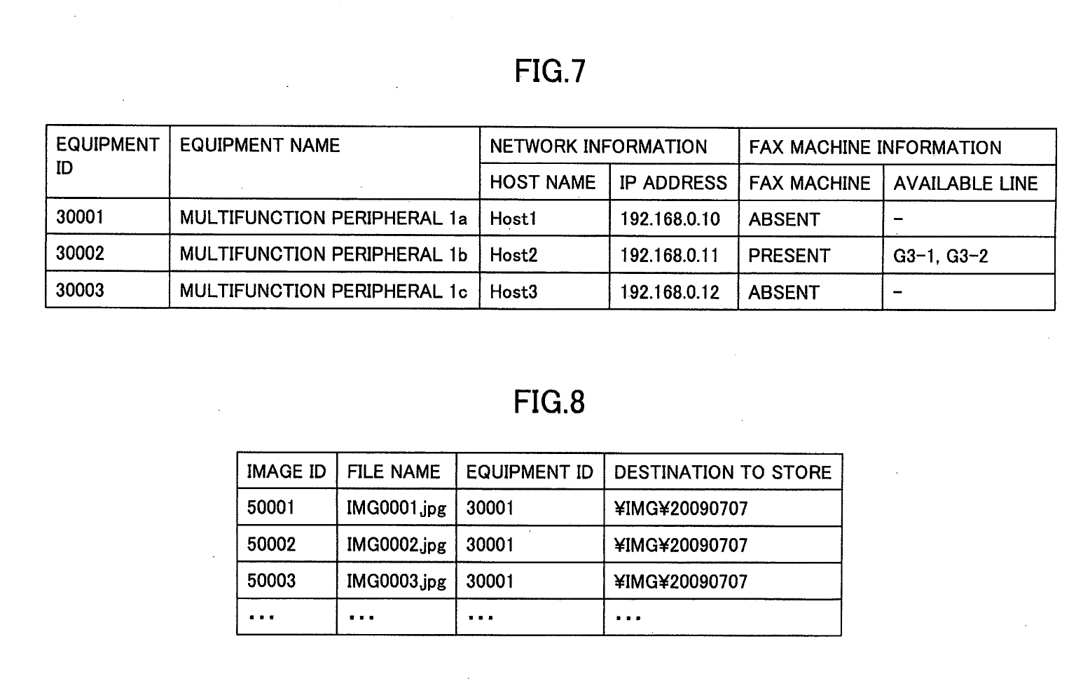

Referring next to FIG. 7, a description is made of the equipment information recorded in the equipment information DB 59 according to the embodiment. FIG. 7 is a diagram showing an example of the equipment information recorded in the equipment information DB according to the embodiment.

As shown in FIG. 7, “equipment IDs,” “equipment names,” “network information,” “FAX machine information,” etc., are recorded as the equipment information recorded in the equipment information DB 59. Further, it is possible to record “host names” and “IP addresses” as the “network information,” and the “presence or absence of FAX machine” and “available lines” as the “FAX machine information.”

Here, the “equipment names” are information displayed on the screen, and the “host names” and the “IP addresses” as the “network information” are information for specifying equipment on the network. Further, the “presence or absence of FAX machine” and the “available lines” are information used for determining whether a FAX transmission job is executable.

Specifically, as shown in FIG. 7, when the “equipment ID” is, e.g., “30002,” it is recorded that the “equipment name” is the “multifunction peripheral 1b,” the “host name” and the “IP address” as the “network information” are “Host2” and “192.168.0.11,” respectively, and the “presence or absence of FAX machine” and the “available line” as the “FAX machine information” are “present” and “G3-1, G3-2,” respectively.

Referring next to FIG. 8, a description is made of the image information recorded in the image information DB 68 according to the embodiment. FIG. 8 is a diagram showing an example of the image information recorded in the image information DB according to the embodiment.

As shown in FIG. 8, “image IDs,” “file names” of images, “equipment IDs” of equipment in which images are stored, “destinations to store” folders in which images are stored, etc., are recorded as the image information recorded in the image information DB 68.

Specifically, as shown in FIG. 8, when the “image ID” is “50001,” it is recorded that the “file name” of an image is “IMG0001.jpg,” the image is stored in equipment having an “equipment ID” of “30001,” and the “destination to store” a folder in which the image is stored is “¥IMG¥20090707.”

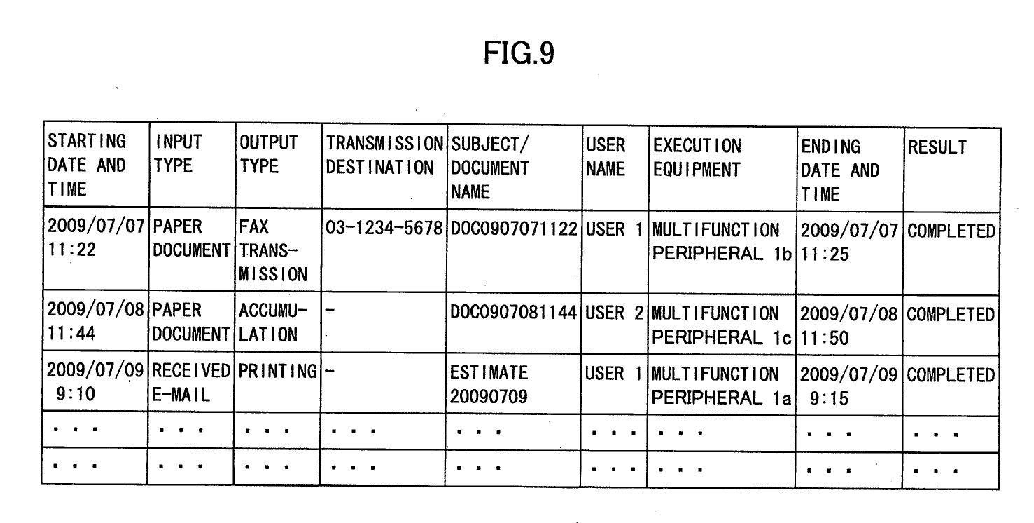

Referring next to FIG. 9, a description is made of the history information recorded in the history information DB 66 according to the embodiment. FIG. 9 is a diagram showing an example of the history information recorded in the history information DB according to the embodiment.

As shown in FIG. 9, “starting dates and times” for executing jobs, “input types,” “output types,” “transmission destinations,” “subjects and document names,” “user names,” “execution equipment,” “ending dates and times,” “results,” etc., are recorded as the history information recorded in the history information DB 66.

Here, the “input types” are information showing methods for acquiring, e.g., images. In other words, the “input types” show the information as to whether the images are read by a scanner, acquired from media, or acquired by FAX reception, e-mail reception, etc. The “output types” are information showing processing applied corresponding to the “input types.” In other words, the “output types” show the information as to which one of FAX transmission, e-mail transmission, accumulation, printing, etc., is applied to the corresponding input type. Further, the “user names” show the information of the users who executed the processing, and the “execution equipment” shows the information of the equipment which executed the processing.

(Job Execution Processing)

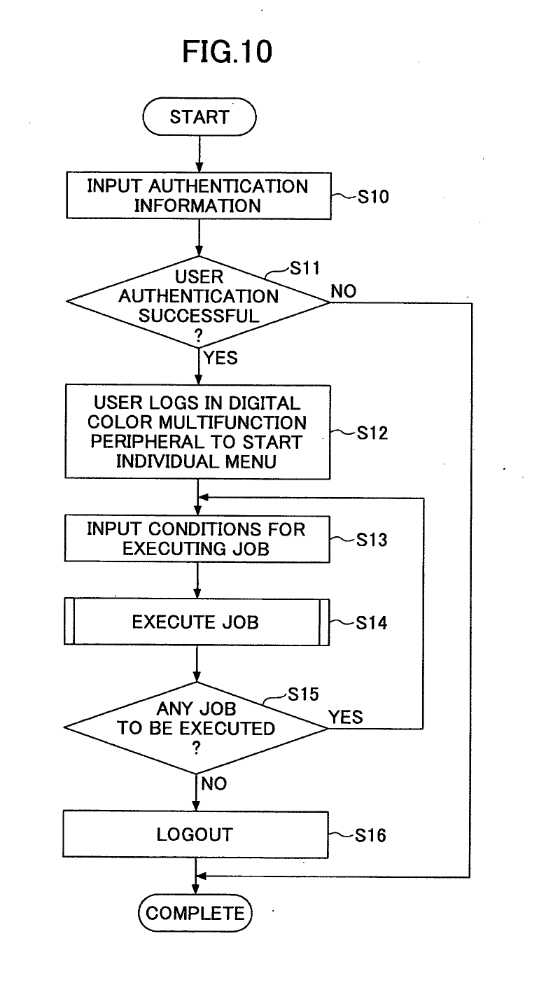

Referring next to FIG. 10, a description is made of the brief overview of processing in which the user logs into one of the digital color multifunction peripherals 1a through 1c to perform an operation for executing a job and then a previously specified digital color multifunction peripheral executes the job. FIG. 10 is a flowchart showing the flow of the job execution processing according to the embodiment.

FIG. 10 describes the processing in which, e.g., the “user 1” logs into the digital color multifunction peripheral 1a to perform the operation for executing FAX transmission and then the line G3-1 of the digital color multifunction peripheral 1b different from the digital color multifunction peripheral 1a which the user 1 is logged into is used to execute the FAX transmission.

Here, the “user 1” belongs to the “group 1,” and it is assumed that members belonging to the “group 1” are required to use the line G3-1 of the multifunction peripheral 1b for FAX transmission. Further, it is assumed that the user's recording information and the equipment information are previously synchronized with each other between the digital color multifunction peripherals 1a and 1b.

As shown in FIG. 10, the “user 1” first inputs authentication information for logging into the digital color multifunction peripheral 1a (in step S10).

Here, as an authentication method, the user 1 inputs a “login user name,” a “login password,” etc. The authentication method is not limited to the above method. For example, the “user 1” may use information contained in an “IC card” allocated to himself or herself and put the same over the operations panel P, etc., of the digital color multifunction peripheral 1a to perform authentication. Further, the “user 1” may perform authentication by using biometrics such as vein authentication.

Next, in the processing of step S10, the display input control unit 51 notifies the authentication control unit 52 of the authentication information input by the “user 1.” Then, the authentication control unit 52 acquires the user information from the registration information control unit 55 and performs user authentication based on the input authentication information to determine whether the user authentication is successful (in step S11). Here, when the user information acquired from the registration information control unit 55 contains the user whose login user name and login password are the same as those of the input authentication information, the authentication control unit 52 determines that “the authentication is successful,” or otherwise determines that “the authentication fails.”

When the user authentication is successful (YES in step S11), the “user 1” logs into the digital color multifunction peripheral 1a. Then, the digital color multifunction peripheral 1a starts an individual menu dedicated to the “user 1” (in step S12). When the user authentication fails (NO in step S11), the processing is completed.

In the processing of step S12, the individual menu control unit 53 acquires the user information and the group information as the registration information of the “user 1” who has been successful in the authentication from the registration information control unit 55, and then instructs the display input control unit 51 to display the screen dedicated to the “user 1” based on the acquired information.

Next, the “user 1” inputs conditions for executing the job on the individual menu screen (in step S13). Here, the conditions for executing the job include the processing of reading a document by a scanner, using an image file contained in a medium, transmitting an acquired image by e-mail or FAX, accumulating the acquired image in the HDD 17, printing the acquired image, or detailed conditions set for each of the processing steps. The display information control unit 51 notifies the individual menu control unit 53 of the information input in the processing of step S13.

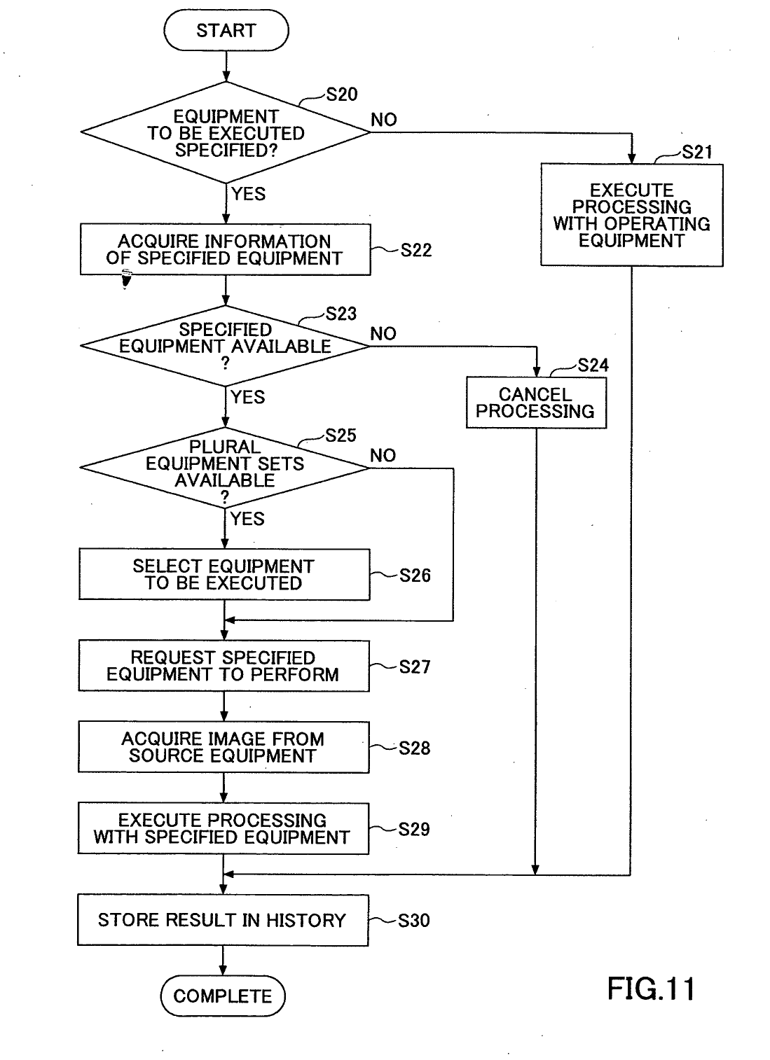

Next, the individual menu control unit 53 notifies the job control unit 57 of the user information and the group information acquired in step S12 and the conditions for executing the job of the “user 1” acquired by the processing of step S13, and then the job control unit 57 requests the digital color multifunction peripheral 1b to execute the job based on the acquired information. Thus, the digital color multifunction peripheral 1b existing on the network executes the job (in step S14). Note that the processing of step S14 is more specifically described with reference to FIG. 11.

When the execution of the job in step S14 is completed, the “user 1” determines whether there is any job remaining to be executed (in step S15). When it is determined that there is no job to be executed (NO in step S15), logout processing for the “user 1” is executed (in step S16) to complete the processing. On the other hand, when it is determined that there is any job to be executed (YES in step S15), the flow returns to the processing of step S13 to set conditions for executing the job again. Note here that when not instructed by the “user 1,” the individual menu control unit 53 may automatically execute the logout processing after a certain period of time.

(Execution Processing of Job Control Unit 57)

Referring next to FIG. 11, a description is made of the processing in which the job control unit 57 executes the job specified by the “user 1.” FIG. 11 is a flowchart showing the flow of the execution processing of the job control unit according to the embodiment.

As shown in FIG. 11, the job control unit 57 determines whether equipment for executing the job is specified based on the user information and the group information as the user's registration information acquired from the individual menu control unit 53 (in step S20).

For example, the user information shown in FIG. 5 contains the “group ID” of the group to which the user belongs. Further, the group information shown in FIG. 6B contains the information as to whether any equipment for executing the job is specified in the “group” corresponding to the “group ID,” the information as to which equipment is used for executing the job, etc.

When determining that the equipment for executing the job is not specified (NO in step S20), the job control unit 57 executes the processing with the equipment being operated by the user (in step S21). In other words, the job control unit 57 executes the job specified by the user with the FAX transmission unit 60 and the e-mail transmission unit 61 of the equipment being operated by the user, and then proceeds to the processing of step S30.

On the other hand, when determining that the equipment for executing the job is specified (YES in step S20), the job control unit 57 acquires the equipment information of the specified equipment (in step S22).

For example, in the case of the “user 1,” the user information shown in FIG. 5 stipulates that the “group ID” is “20001,” and the group information shown in FIG. 6B stipulates that the “equipment is specified” for FAX transmission when the “group ID” is “20001.” Further, it is stipulated that the specified equipment should have “30002” as the “equipment ID” and “G3-1” as the “line.” Accordingly, in the case of the “user 1,” the job control unit 57 determines in the processing of step S20 that the equipment for executing the job is specified, and then proceeds to the processing of step S22.

The job control unit 57 determines whether the specified equipment is available based on the equipment information acquired by the processing of step S22 (in step S23). Note that the equipment information is synchronized among the equipment sets connected on the network. As shown in FIG. 7, the equipment information contains not only the information of the own peripheral being operated by the user but also the information of other peripherals on the network. In addition, the equipment information contains the presence or absence of a FAX machine, available lines, etc.

Here, when the specified equipment cannot be used due to, e.g., the absence of a FAX machine (NO in step S23), the job cannot be executed. Therefore, the job control unit 57 cancels the job and proceeds to the processing of step S30.

For example, in the case of the “user 1,” the job control unit 57 acquires the equipment information containing “30002” as the “equipment ID” and the “multifunction peripheral 1b” as the “equipment name” from the equipment information shown in FIG. 7 in the processing of step S22. Since the “FAX machine is present” and the “line G3-1 is available” in the “multifunction peripheral 1b” based on the acquired equipment information in the processing of step S23, the job control unit 57 determines that the specified equipment is available and then proceeds to the processing of step S25.

After determining that the specified equipment is available (YES in step S23), the job control unit 57 then determines whether the specified equipment can be one of plural equipment sets (in step S25).

For example, as shown in FIGS. 5, 6A, and 6B, the “group ID” of the “user 3” includes'“20001” and “20002” which belong to the “group 1” and the “group 2,” respectively. Accordingly, when the “user 3” performs FAX transmission, the user 3 can use both the digital color multifunction peripheral 1a and the digital color multifunction peripheral 1b. Note that when the user belongs to plural groups, it is assumed that the user holds operations concurrently over plural departments.

As described above, when determining that the specified equipment can be one of the plural equipment sets (YES in step S25), the job control unit 57 causes the user to select the equipment to be executed (in step S26).

Here, the job control unit 57 notifies the individual menu control unit 53 of a list of the available equipment. The individual menu control unit 53 causes the display input control unit 51 to display the list of the equipment and the user to select the equipment to be used. A result selected by the user is sent from the display input control unit 51 to the individual menu control unit 53, and then sent from the individual menu control unit 53 to the job control unit 57.

Note that when any of the equipment to be preferentially used is determined in advance for each user instead of the selection by the user in the processing of step S26, the equipment may be automatically selected based on the determination. For example, the user information shown in FIG. 5 can contain equipment specification information to be preferentially used for each user.

On the other hand, when there is only one equipment set available, the job control unit 57 determines that the specified equipment cannot be plural of the equipment sets (NO in step S25), and then requests the specified equipment to execute the job (in step S27).

For example, in the case of the “user 1,” since it is stipulated that the “user 1” belongs to only the “group 1,” the equipment used for FAX transmission is the “multifunction peripheral 1b,” and the line used is the “G3-1,” the job control unit 57 determines in the processing of step S25 that an operation by the user for selecting the equipment is unnecessary, i.e., the specified equipment cannot be plural of the equipment sets, and then proceeds to the processing of step S27.

Next, the job control unit 57 requests the job control unit 57 of the equipment specified in the processing of steps S25 and S26 to execute the job (in step S27). Here, the job control unit 57 of the equipment being operated by the user transmits the conditions for executing the job specified by the user and the information of the image file used for the job to the job control unit 57 of the specified equipment via the network.

Note that the job control units and the image information control units of the digital color multifunction peripherals 1a and 1b are job control units 57a and 57b and image information control units 67a and 67b, respectively. For example, the job control unit 57a of the digital color multifunction peripheral 1a being operated by the “user 1” transmits the conditions for FAX transmission and the information of the image file used for FAX transmission to the job control unit 57b.

Next, the job control unit 57 of the specified equipment acquires the image file used for the job (in step S28). First, the job control unit 57 of the specified equipment notifies the image information control unit 67 of the own equipment of the image information acquired by the processing of step S27 and requests for the acquisition of the image file.

The image information control unit 67 determines whether the image file to be acquired is contained in other equipment from the acquired image information. When determining that the image file is contained in other equipment, the image information control unit 67 acquires the image file via the image information control unit 67 of the other equipment. The image information control unit 67 transmits the image file acquired from the image information control unit 67 of the other equipment to the job control unit of the own equipment.

For example, in the processing of step S27, the job control unit 57b, which is requested by the job control unit 57a of the digital color multifunction peripheral 1a being operated by the “user 1” to perform FAX transmission, requests the image information control unit 67b to acquire the image file used for FAX transmission.

In the processing of step S28, the image information control unit 67b determines that the image file indicated by the image information to be acquired is contained in the digital color multifunction peripheral 1a based on the image information shown in FIG. 8, and requests the image information control unit 67a to transmit the image file via the network. Then, the image information control unit 67a transmits the requested image file to the image information control unit 67b via the network. After receiving the image file from the image information control unit 67a, the image information control unit 67b transmits the image file to the job control unit 57b. Thus, the job control unit 57b acquires the image from the equipment as a request source.

Next, the job control unit 57 of the specified equipment executes the job by using the FAX transmission unit 60 and the e-mail transmission unit (in step S29). Further, the job control unit 57 of the specified equipment notifies the job control unit 57 as the request source of an execution result.

For example, the job control unit 57b of the specified equipment that executes the job of the “user 1” requests the FAX transmission unit 60b to perform FAX transmission, and the FAX transmission unit 60b executes FAX transmission. The FAX transmission unit 60b notifies the job control unit 57b of an execution result. The job control unit 57b notifies the job control unit 57a of the result.

Next, the job control unit 57 as the request source notifies the history information control unit 65 of the execution result, the history information control unit 65 stores the execution result information in the history information DB 66 (in step S30), and the job control unit 57 completes the processing. Note that in this example, the result is stored in the history information DB 66 after the execution of the job. However, execution statuses may be stored at any time as the history information during the execution of the job.

As described above, when, e.g., the “user 1” logs into the digital color multifunction peripheral 1a and performs an operation for FAX transmission, the line “G3-1” of the multifunction peripheral 1b different from the multifunction peripheral 1a being operated is automatically used. The equipment is selected and the processing is executed based on the previously-set user's registration information, etc., not only for the execution of the job of FAX transmission described above, but also for e-mail transmission, file transfer, print output, accumulation and management of image files, etc.

Further, the “user 1” can obtain the same result by using the digital color multifunction peripherals 1b and 1c other than the digital color multifunction peripheral 1a.

Note that in order to use the same service with one of the digital color multifunction peripherals 1 connected to the job management system 100, the user's registration information, equipment information, etc., may be recorded in the server computer 2 or the client computer 3 in the job management system 100, other than recording the user's registration information, equipment information, etc., in the digital color multifunction peripherals 1 and synchronizing these information sets with each other.

In this case, when the “user 1” logs into one of the digital color multifunction peripherals 1, the registration information control unit 55, the equipment information control unit 58, etc., of the digital color multifunction peripheral in which the “user 1” is logged into acquires the user's registration information, equipment information, etc., from the server computer 2 or the client computer 3 via the network. In this manner, the same effect as when the user's registration information, equipment information, etc., of plural digital color multifunction peripherals are synchronized with each other can be obtained.

Note that in this embodiment, the equipment specification information is configured to be recorded for each group. However, the equipment specification information may be recorded for each user. In this case, the equipment information is set as, e.g., the user information shown in FIG. 5, and the job control unit 57 selects the equipment for executing the job based on the set equipment specification information.

As described above, according to the embodiment, the user's registration information, equipment information, etc., are synchronized among the plural information processing apparatuses connected to the network. Therefore, when the user performs a login operation with one of the plural information processing apparatuses, the corresponding information processing apparatus for executing the job is automatically selected based on the predetermined conditions. Thus, it is possible for the user to save the labor of selecting an apparatus by himself or herself to execute the job and prevent the user from wrongly selecting the apparatus to be used.

Therefore, according to the embodiment, it is possible for the user to select one of plural information processing apparatuses based on predetermined conditions to execute a job without selecting an apparatus for executing the job from the plural information processing apparatuses connected to a network.

The present invention is not limited to the specifically disclosed embodiments, and variations and modifications may be made without departing from the scope of the present invention.

The present application is based on Japanese Priority Application No. 2009-213752 filed on Sep. 15, 2009, the entire contents of which are hereby incorporated herein by reference.

What is claimed is:

1. A job management system having plural information processing apparatuses connected to each other via a network capable of transmitting and receiving information, wherein the information processing apparatus comprises:
a job control unit that selects one of the plural information processing apparatuses to execute a requested job based on user's registration information and equipment information recorded in the plural information processing apparatuses and causes the selected one of the plural information processing apparatuses to execute the requested job.

2. The job management system according to claim 1, wherein the information processing apparatus further comprises:
a registration information control unit that records the user's registration information; and
an equipment information control unit that records the equipment information,
the registration information control unit synchronizing the user's registration information with user's registration information recorded in other of the information processing apparatuses,
the equipment information control unit synchronizing the equipment information with equipment information recorded in the other of the information processing apparatuses.

3. The job management system according to claim 2, wherein in order to record the user's registration information and the equipment information on an external apparatus connected to the network,
the registration information control unit and the equipment information control unit acquire the user's registration information and the equipment information from the external apparatus.

4. The job management system according to claim 1, wherein the information processing apparatus further comprises:
an authentication unit that authenticates a user, and
the job control unit causes one of the plural information processing apparatuses available to the user to execute the job based on an authentication result obtained by the authentication unit.

5. The job management system according to claim 1, wherein
the job control unit
determines whether any of the plural information processing apparatuses is specified to execute the job based on the user's registration information,
determines, when said any of the plural information processing apparatuses is specified', whether said any of the plural specified information processing apparatuses is available based on the equipment information, and
causes, when the job control unit determines that plural of the information processing apparatuses are specified to execute the job and at least two of the plural information processing apparatuses are available, one of the at least two information processing apparatuses selected by the user or the information processing apparatus selected based on previously-set equipment specification information that specifies the user allowed to preferentially use to execute the job.

6. An information processing apparatus connected to plural of the information processing apparatuses via a network capable of transmitting and receiving information, the information processing apparatus comprising:
a job control unit that selects one of the plural information processing apparatuses to execute a requested job and causes the selected one of the plural information processing apparatuses to execute the job.

7. The information processing apparatus according to claim 6, further comprising:
a registration information control unit that records the user's registration information; and
an equipment information control unit that records the equipment information,
the registration information control unit synchronizing the user's registration information with user's registration information recorded in other of the information processing apparatuses,
the equipment information control unit synchronizing the equipment information with equipment information recorded in the other of the information processing apparatuses.

8. The information processing apparatus according to claim 7, wherein in order to record the user's registration information and the equipment information on an external apparatus connected to the network,
the registration information control unit and the equipment information control unit acquire the user's registration information and the equipment information from the external apparatus.

9. The information processing apparatus according to claim 6, further comprising:
an authentication unit that authenticates a user; wherein
the job control unit causes one of the plural information processing apparatuses available to the user to execute the job based on an authentication result obtained by the authentication unit.

10. The information processing apparatus according to claim 6, wherein
the job control unit
determines whether any of the plural information processing apparatuses is specified to execute the job based on the user's registration information,
determines, when said any of the plural information processing apparatuses is specified, whether said any of the plural specified information processing apparatuses is available based on the equipment information, and
causes, when the job control unit determines that plural of the information processing apparatuses are specified to execute the job and at least two of the plural information processing apparatuses are available, one of the at least two information processing apparatuses selected by the user or the information processing apparatus selected based on equipment specification information that specifies the user allowed to preferentially use to execute the job.

11. An information processing method executed by a job management system having plural information processing apparatuses connected to each other via a network capable of transmitting and receiving information, the information processing method comprising:
a selection step of selecting one of the plural information processing apparatuses to execute a requested job based on user's registration information and equipment information recorded in the plural information processing apparatuses; and
a job control step of causing the one of the plural information processing apparatuses selected by the selection step to execute the requested job.

12. The information processing method according to claim 11, further comprising:
a registration information control step of recording the user's registration information; and
an equipment information control step of recording the equipment information; wherein
the registration information control step synchronizes the user's registration information with user's registration information of other of the information processing apparatuses, and
the equipment information control step synchronizes the equipment information with equipment information of the other of the information processing apparatuses.

13. The information processing method according to claim 12, wherein in order to record the user's registration information and the equipment information on an external apparatus connected to the network,
the user's registration information and the equipment information are acquired from the external apparatus in the registration information control step and the equipment information control step.

14. The information processing method according to claim 11, further comprising:
an authentication step of authenticating a user; wherein
the job control step causes one of the plural information processing apparatuses available to the user to execute the job based on an authentication result obtained by the authentication step.

15. The information processing method according to claim 11, wherein
the selection step
determines whether any of the plural information processing apparatuses is specified to execute the job based on the user's registration information,
determines, when said any of the plural information processing apparatuses is specified, whether said any of the plural specified information processing apparatuses is available based on the equipment information, and
selects, when the job control step determines that plural of the information processing apparatuses are specified to execute the job and at least two of the plural information processing apparatuses are available, one of the at least two information processing apparatuses selected by the user, or selects the information processing apparatus that executes the job based on previously-set equipment specification information that specifies the user allowed to preferentially use, and
the job control step causes the information processing apparatus selected by the selection step to execute the job.
